(19) United States
(12) Patent Application Publication
(10) Pub. No.: US 2017/0024475 A1
(43) Pub. Date: Jan. 26, 2017

(54) INTELLIGENT CLOUD SEARCH SYSTEMS AND ENGINEERING PURCHASE SERVICE SYSTEMS

(71) Applicant: I Chang Chen, New Taipei City (TW)

(72) Inventor: I Chang Chen, New Taipei City (TW)

(21) Appl. No.: 14/981,918

(22) Filed: Dec. 29, 2015

(30) Foreign Application Priority Data
Jul. 23, 2015 (TW) 104123868

(51) Int. Cl. G06F 17/30; G06Q 10/06; G06Q 30/06; H04L 29/08

(52) U.S. Cl. CPC G06F 17/30867; H04L 67/1097; G06F 17/30528; G06Q 10/06315; G06Q 30/0611

(57) ABSTRACT

The present application provides an intelligent cloud search system including a control module, a cloud transmission module, a cloud edit module, a cloud computation module and a synonym search module. The control module control operations of the intelligent cloudsearch system, and includes a storage module, which stores at least a user document of a user. The cloud transmission module transmits the user document via a cloud network, and the user document has at least a historical information. The cloud edit module performs an edit process to the historical information of the user document via the cloud network. The cloud computation module performs a computation process to the historical information of the user document via the cloud network. The synonym search module searches at least a real-time information synonymous to the historical information via the cloud network. The present application further provides an engineering purchase service system.

### CROSS-REFERENCE TO RELATED APPLICATION

This application claims the priority of Taiwanese patent application No. 104123868, filed on Jul. 23, 2015, which is incorporated herewith by reference.

### BACKGROUND OF THE INVENTION

1. Field of the Invention

The present application relates to a search system, and particularly to an intelligent cloud search system implemented in a cloud and capable of performing multitasking with respect to search. The present application relates to an engineering purchase service system which can be integrated with the intelligent cloud search system.

2. The Prior Art

Recently, with rise of environmental awareness, both government organizations of each nation and each enterprise continue to implement paperless management and processing flow, and to substitute conventional paper with electronic platforms not only reduces deforestation but also cost expenditure of the government organizations and the enterprises. On the other hand, data of the electronic platforms are stored in digitalization forms, so that computing processes and remote transmission of the data further have convenience. With reliance of the people on the digitalization information, quantities of accumulated data are increasingly large, the rate and accuracy of searching the required data become extremely important at the present time, especially for commercial activities which need real-time information, such as engineering bidding search, commodity trading search, shares currency trading and the like. In response to the changing commercial demand, people developed a commercial database system.

Please refer to FIG. 1, which illustrates a common commercial database system of conventional technique, the common commercial database system includes a central processor 10, a storage module 11, an edit module 12, a communication module 13, wherein the central processor 10 controls operations of the common commercial database system, and the central processor 10 is used for performing an computation process to at least a commercial information; the storage module 11 is connected to the central processor 10, and the storage module 11 has at least a commercial information stored therein; the edit module 12 is connected to the central processor 10 and the storage module, and the edit module 12 is used for performing an edit process to the commercial information; the communication module 13 is then connected to the central processor 10 and the storage module 11, and the communication module 13 is used for transmitting the commercial information between a client end and the storage module 11. In use of the aforesaid common commercial database system of conventional technique, at least a commercial information of at least a client end is transmitted to the storage module 11 through the communication module 13, and the computation process and the edit process are then performed to the commercial information through the central processor 10 and the edit module 11; after all the processes are completed, at least a commercial information of the processes completed can be transmitted to at least a designated client end; thus, the user can respectively perform the edit process, the computation process and the transmission process to the commercial information by operating the common commercial database of the conventional technique.

However, when the servo of aforesaid commercial database performs the computation process to the commercial information, the servo thereof cannot automatically and synchronously perform the works of online edit, third-party transfer and online real-time/historical search and specification search to the commercial information, and this results in limitations on implementation efficiency and operation function.

Therefore, a technical problem urgently needed to be solved is to provide a system which can respectively or synchronously perform the works of online edit, third-party transfer, online real-time/historical search and specification search, and then has preferable implementation efficiency and functionality on commercial use.

### SUMMARY OF THE INVENTION

In view of the aforesaid drawbacks of conventional technique, a main aspect of the present application is to provide an intelligent cloud search system which can respectively or synchronously perform actions of online edit, string parse computation, online search and information transmission so as to meet an object of increasing commercial efficiency and functionality.

Another aspect of the present application is to provide an engineering purchase service system which can be integrated with the intelligent cloud search system so as to meet an object of instant and convenient engineering purchase service.

In order to meet the said and other objects, the intelligent cloud search system of the present application includes: a control module, controlling operations of the intelligent cloud search system and including a storage module, wherein the storage module stores at least a user document of at least a user; a cloud transmission module, connected to the control module and transmitting the user document having at least a historical information via a cloud network; a cloud edit module, connected to the control module and performing an edit process to the historical information of the user document via the cloud network; a cloud computation module, connected to the control module and performing a computation process to the historical information of the user document via the cloud network; and a synonym search module, connected to the control module and performing a search for at least a real-time information synonymous to the historical information via the cloud network.

Preferably, according to an embodiment of the present application, the intelligent cloud search system of the present application further includes a public construction cost estimate system (PCCES) file producing module which has an algorithm and converts the user document to a file compatible to a format of PCCES.

Preferably, according to an embodiment of the present application, the intelligent cloud search system is installed and disposed in a smart phone, a tablet computer, a notebook computer or a personal computer of the user.

Preferably, according to an embodiment of the present application, the cloud transmission module includes a mobile application module and a web page application module, the mobile application module is connected to at least a mobile communication device, and the web page application module is connected to at least a terminal device.

Preferably, according to an embodiment of the present application, the real-time information and the historical information includes one of a financial statement, an engineering quotation, a budget compilation, a research paper and a publication work, and/or a combination thereof

Preferable, according to an embodiment of the present application, the synonym search module includes a search module and a synonym identification module, the search module performs a search for the real-time information and/or the historical information via the cloud network, the synonym identification module performs a synonym identification to the real-time information and/or the historical information via the cloud network.

Preferably, according to an embodiment of the present application, the synonym identification module includes an artificial neural network (ANN) computation model.

Preferably, according to an embodiment of the present application, the cloud computation module includes a string parse unit and a formula computation unit, the string parse unit performs a string parse to the historical information in the user document, and the formula computation unit performs a formula computation to the historical information in the user document.

Preferably, according to an embodiment of the present application, the intelligent cloud search system of the present application further includes an identity identification module, which performs an identification to an identity information of the user via the cloud network, the identity information includes one of a password, a phone number, a birthday, a fingerprint, a voiceprint, an electronic mail, a face recognition and a QR Code, and/or a combination thereof

Preferably, according to an embodiment of the present application, the cloud edit module is compatible to documentation format of Microsoft Office, OpenOffice and hypertext markup language (HTML).

In beginning of implementing the present application, the user stores at least a user document in the system by the control module, and edits the user document stored in the system on the cloud network by the cloud edit module. When the cloud edit module performs an edit action to the user document, the control module coordinates the cloud computation module, the cloud transmission module and the synonym search module to respectively or synchronously perform the computation process, the transmission process or the search for synonymous real-time information and/or synonymous historical information to the user document, so as to achieve a preferable implementation efficiency and functionality; especially, the synonym search module is capable of searching synonyms synonymous each other on the cloud network, so as to effectively increase accuracy and objective measurement of searching information; and thus, the intelligent cloud search system of the present application can meet the objects of increasing commercial efficiency and functionality.

In engineering industries, from design, tender, contract, construction to completion, an engineering case relates to various professional techniques and materials. Most current engineering business websites are built on individual companies or manufacturers, which mainly focus on providing sale of their product or service but fail to integrate large and complex information of the engineering industries. On lacking of information integrating platform, on one hand, a demander of an engineering case takes much time for selecting suitable material or service suppliers by filtering a lot of sale information; on the other hand, the material or service suppliers of the engineering case also take manpower to find out the fleeting tender opportunity.

For effectively integrating information of the upstream and downstream engineering industries so as to provide an instant and convenient engineering purchase service, the present application further provides an engineering purchase service system which can be integrated with the intelligent cloud search system of the present application.

The engineering purchase service system includes a supply-demand database, a receiver module, a processing module and a transmission module. The supply-demand database has stored historical transaction data of at least a demand end and supply data of a plurality of supply ends. The receiver module receives inquiry data transmitted by the demand end through a network, and the inquiry data includes a demand object and a preset condition. The processing module performs synonym retrieval to the historical transaction data and the supply data according to the demand object so as to produce a plurality of candidate supply ends conforming to the demand object, and the processing module filters the plurality of candidate supply ends according to the preset condition so as to produce at least an inquiry supply end and an inquiry form conforming to the preset condition, wherein the inquiry form includes the supply data of the inquiry supply end corresponding to the demand object. The transmission module transmits the inquiry form to the inquiry supply end via the network.

The engineering purchase service system of the present application can be integrated with the demand ends or the supply ends having installed the intelligent cloud search system of the present application. The engineering purchase service system of the present application includes the supply-demand database, the receiver module, the processing module and the transmission module, wherein the processing module perform the synonym retrieval to the historical transaction data and the supply data stored in the supply-demand database according to the inquiry data transmitted by the demand end, then the processing module produces at least an inquiry supply end and an inquiry form conforming to the inquiry data, and the transmission module can automatically transmit the inquiry form to the inquiry supply end. By integrating the historical transaction data of the demand ends and the supply data of the supply ends, the engineering purchase service system of the present application can automatically produce the forms relative to the engineering purchase such as inquiry, quotation, contract and the like, the engineering industries can use the engineering purchase service system to complete all the engineering purchase jobs, so that manpower and operation time of the engineering purchase jobs can be significantly reduced, and an instant and convenient engineering purchase service can be obtained.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic block diagram illustrating a commercial database system of conventional technique;

FIG. 2 is a schematic block diagram illustrating an intelligent cloud search system according to an embodiment of the present application;

FIG. 3 is a schematic block diagram illustrating a cloud transmission module according to an embodiment of the present application;

FIG. 4 is a schematic block diagram illustrating a cloud computation module according to an embodiment of the present application;

FIG. 5 is a schematic block diagram illustrating a synonym search module according to an embodiment of the present application.

FIG. 6 is a block diagram illustrating an engineering purchase service system of the present application;

FIG. 7 is a step flowchart illustrating an inquiry service for the demand end provided by the engineering purchase service system; and

FIG. 8 is a step flowchart illustrating a contracting service for the demand end provided by the engineering purchase service system.

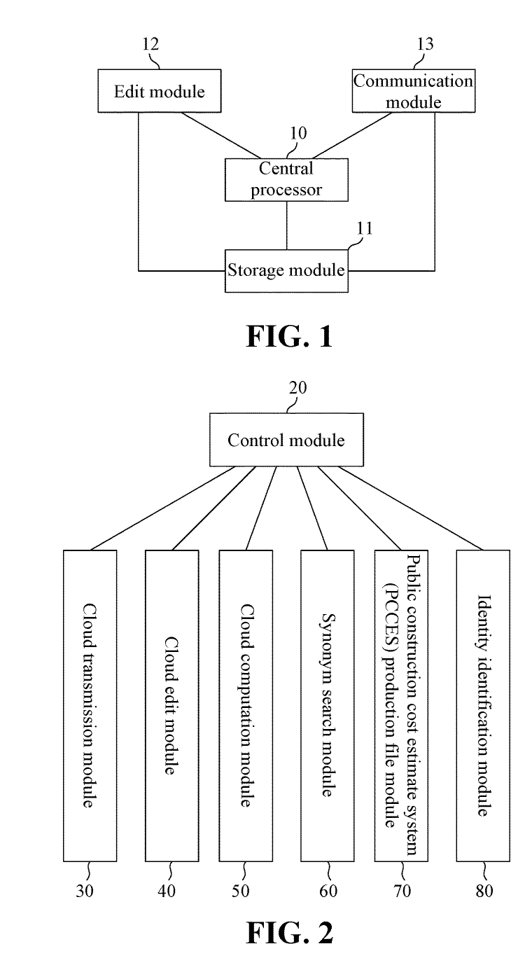

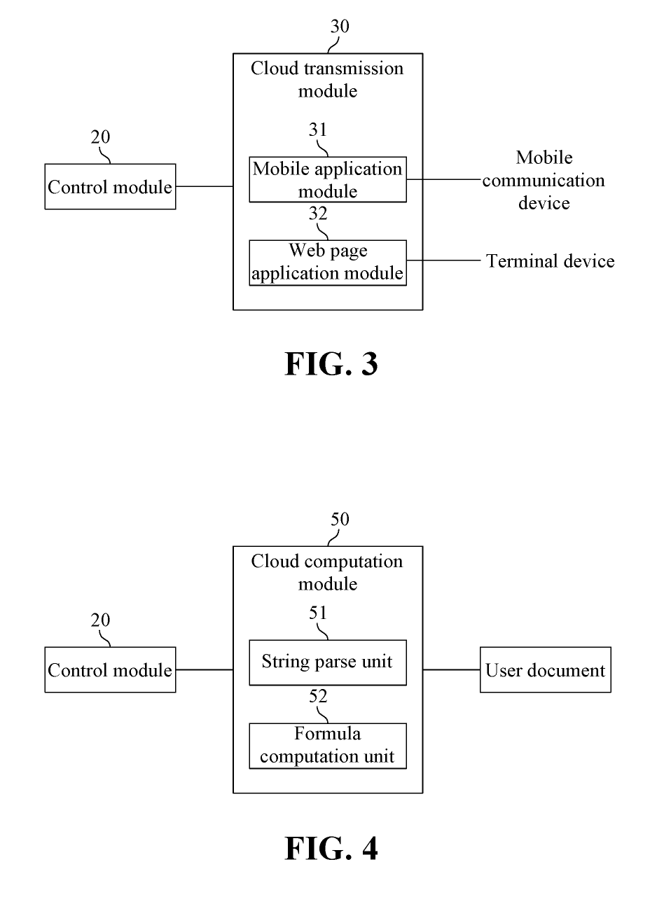

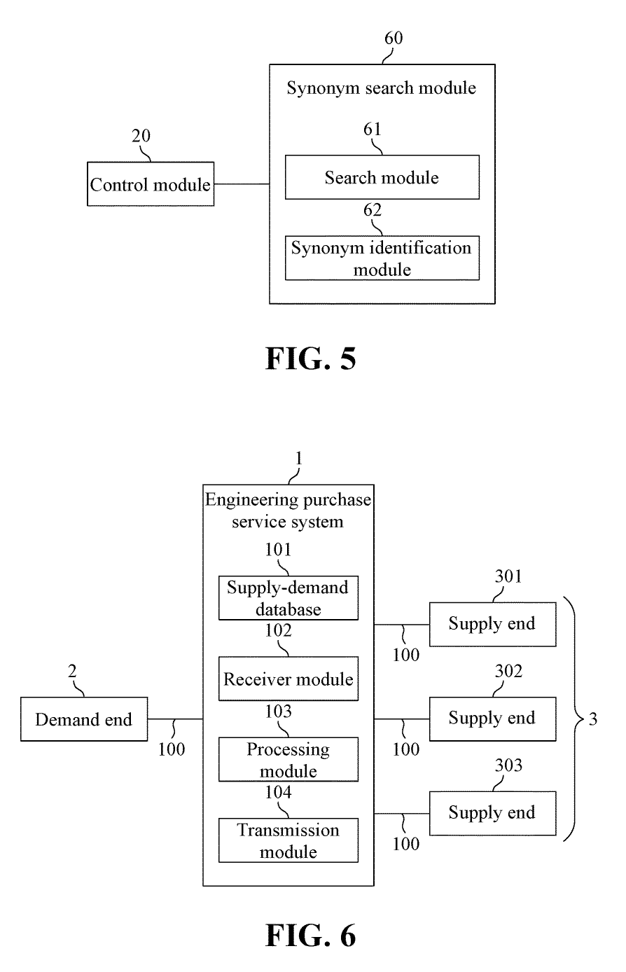

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

An intelligent cloud search system according to an embodiment of the present application is described as follows.

Please refer to FIG. 2, an intelligent cloud search system of the present application includes: a control module 20, a cloud transmission module 30, a cloud edit module 40, a cloud computation module 50 and a synonym search module 60. In an embodiment of the present application, the intelligent cloud search system can be installed and disposed in a smart phone, or a tablet, notebook or personal computer of a user.

In the system, the control module 20 controls operations of the intelligent cloud search system, and the control module 20 includes a storage module (not shown), which stores at least a user document of the user. In an embodiment of the present application, the control module 20 coordinates the cloud edit module 30, the cloud computation module 40, the synonym search module 50 and the cloud transmission module 60 to respectively or synchronously operate, so as to achieve preferable implementation efficiency and functionality.

The cloud transmission module 30 is connected to the control module 20, and the cloud transmission module 30 transmits the user document via a cloud network, and the user document has at least a historical information. In an embodiment of the present application, the historical information includes a financial statement, an engineering quotation, a budget compilation, a research paper and a publication work, and/or a combination thereof. In this embodiment, the cloud transmission module 30 includes a mobile application module 31 and a web page application module 32, wherein the mobile application module 31 is connected to at least a mobile communication device such as a smart phone, a tablet computer, personal digital assistant (PDA), GPS or GLONASS and the like; and the web page application module 32 is connected to at least a terminal device such as a desktop PC, a video wall.

The cloud edit module 40 is connected to the control module 20, and perform an edit process to the historical information of the user document via the cloud network. In an embodiment of the present application, the cloud edit module is compatible to documentation format of Microsoft Office, OpenOffice and hypertext markup language (HTML).

The cloud computation module 50 is connected to the control module 20, and the cloud computation module 50 performs a computation process to the historical information of the user document via the cloud network. In an embodiment of the present application, the cloud computation module 50 includes a string parse unit 51 and a formula computation unit 52, wherein the string parse unit 51 performs a string parse to the historical information of the user document according to a preset string condition; and the formula computation unit 52 performs a formula computation to the historical information of the user document.

The synonym search module 60 is connected to the control module 20, and search at least a real-time information synonymous to the historical information via the cloud network. In an embodiment of the present application, the synonym search module 60 can include a search module 61 and a synonym identification module 62. The search module 61 performs a search for the real-time information and/or the historical information via the cloud network, wherein the real-time information is a latest information which can be searched in the cloud network, and the real-time information includes one of a financial statement, an engineering quotation, a budget compilation, a research paper and a publication work, and/or a combination thereof. The synonym identification module 62 includes an ANN computation model, and performs a synonym identification to the real-time information and/or the historical information via the cloud network. For example, when the search module 61 searches “bicycle”, the synonym identification module 62 can identify synonyms “bike”, “iron horse”, “two-wheeler”, “tandem bicycle”. When the search module 61 searches “2000 pound concrete”, the synonym identification module 62 can identify synonyms “141 kg/cm² conc”, “2000 psi conc”, “141 kg/cm² concrete”, “2000 psi concrete”, “2000 pound concrete”.

According to an embodiment of the present application, the intelligent cloud search system can further include a PCCES file producing module 70 which has an algorithm and converts the user document to a file compatible to a format of PCCES. In an embodiment of the present application, a format of PCCES can be xlsx, xml or xls.

According to an embodiment of the present application, the intelligent cloud search system further includes an identity identification module 80 which performs identification to an identity information of the user via the cloud network. In an embodiment of the present application, the identity information can include one of a password, a phone number, a birthday, a fingerprint, a voiceprint, an electronic mail, a face recognition and a QR Code, and/or a combination thereof

In beginning of implementing an embodiment of the present application, the user performs an identification to the identity information through the identity identification module 80 in the cloud network to obtain a use right of the system; then the user stores at least a user document in the system through the control module 20, and the user can edit the user document stored in the system on the cloud network through the cloud edit module 40. When the cloud edit module 40 performs an edit action to the user document stored in the system, the control module 20 coordinates the cloud computation module 50, the cloud transmission module 30 and the synonym search module 60 to respectively or synchronously perform a computation process, a transmission process or a search for the synonymous real-time information and/or the synonymous historical information to the user document, so as to achieve a preferable implementation efficiency and functionality. For example, when the user performs an edit action to the user document through the cloud edit module 40, the user can synchronously search information of company or manufacturer data and the like through the synonym search module 60; especially, the synonym search module 60 is capable of searching synonyms synonymous each other on the cloud network, so as to effectively increase accuracy and objective measurement of searching information; and thus, the present application can meet the objects of increasing commercial efficiency and functionality.

The present application further provides an engineering purchase service system which can be integrated with the intelligent cloud search system of the present application for providing an instant and convenient engineering purchase service.

FIG. 6 is a block diagram illustrating an engineering purchase service system of the present application. As shown in FIG. 6, the engineering purchase service system 1 built in a cloud includes a supply-demand database 101, a receiver module 102, a processing module 103 and a transmission module 104, wherein the supply-demand database 101 has stored a historical transaction data of at least a demand end 2 and supply data of a plurality of supply ends 3 (for example, supply end 301, 302, 303, . . . ). The demand end 2 and the plurality of supply end 3 can connect to the engineering purchase service system 1 via a network 100. The network 100 can be Internet or a local area network.

In engineering industries, construction companies, design companies, building manufacturers and build material manufacturers can be upstream supply ends in one hand, also downstream demand ends in the other hand. The engineering purchase service system 1 of the present application can integrate information of upstream and downstream companies and manufacturers in engineering industries, users of engineering industries can use company servo, or any personal computer or mobile communication devices capable of connecting to the network 100 to log in the engineering purchase service system 1, and then they can select to be the demand end 2 or the supply end 3. The demand end 2 or the supply ends 3 can operate a tool menu on a web page of the engineering purchase service system 1 to perform jobs relative to the engineering purchase such as data upload, inquiry, quotation, form preparation and the like. In an embodiment, the demand end 2 has installed the intelligent cloud search system of the present application, when the demand end 2 transmits the inquiry data, the intelligent cloud search system installed therein can synchronously transmit an instruction of performing the synonym retrieval according to the demand object.

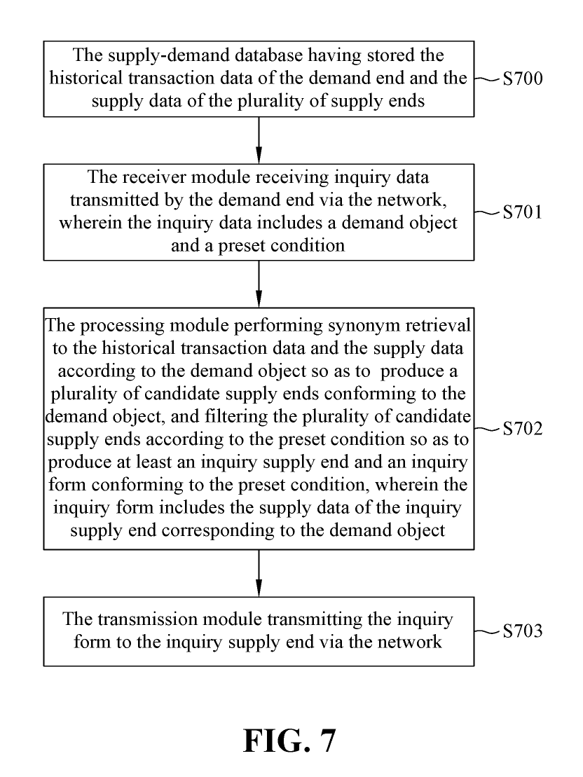

FIG. 7 is a step flowchart illustrating an inquiry service for the demand end provided by the engineering purchase service system. As shown in FIG. 7, in step S700, the supply-demand database 11 has initially stored the historical transaction data of the demand end 2 and the supply data of the plurality of supply ends 3 (the supply ends 301, 302, 303); in step S701, the receiver module 11 receives inquiry data transmitted by the demand end 2 via the network 100, wherein the inquiry data includes a demand object and a preset condition; in step S702, the processing module 103 performs synonym retrieval to the historical transaction data and the supply data according to the demand object so as to produce a plurality of candidate supply ends conforming to the demand object, and the processing module 103 filters the plurality of candidate supply ends (for example, the supply ends 301 and 302) according to the preset condition so as to produce at least an inquiry supply end (for example, the supply end 301) and an inquiry form conforming to the preset condition, wherein the inquiry form includes the supply data of the inquiry supply end corresponding to the demand object; in step S703, the transmission module 104 transmits the inquiry form to the inquiry supply end (the supply end 301) via the network 100.

In details, the web pages of the engineering purchase service system 1 provide classification groups for different engineering companies or manufacturers as the demand end 2 or the supply end 3 to input the historical transaction data or the supply data. Each group can include hierarchical items in which the item located on an upper hierarchy can further include the items located on a lower hierarchy and an input field, so to the common transaction items in the engineering industries located on a bottom hierarchy. More than one item of each hierarchy can be selected to be the businesses of the demand end 2 and the supply end 3, and the input field can be entered keywords relative to their businesses thereof.

The classification groups includes such as “design/supervision”, “building contractors”, “construction companies”, “suppliers”; each group includes the first hierarchical items such as “member information” and “company information”; the first hierarchical item “company information” includes the second hierarchical items and the input field, the second hierarchical items are such as “type of business” and “service location”, and the input field is for inputting business items of members (i.e. the demand ends 2 and the supply ends 3) of the engineering purchase service system 1; the second hierarchical item “type of business” includes the third hierarchical items such as “manufacture”, “wholesale and retail”, “construction/installation”, “work including material”, etc.; each the third hierarchical items can further include common transaction items in the engineering industries, for example, standard work items of respective engineering formulated by Public Construction Commission of the government. The supply-demand database 101 then stores the historical transaction data and the supply data of the demand ends 2 and the supply ends 3 according the classification groups and the hierarchical items.

The inquiry service process provided by the engineering purchase service system 1 will be more specifically described in following embodiment with a designer as the demand end 2 and building material suppliers as the supply ends 3.

In step S700, the demand end 2 (the designer) and the plurality of the supply ends 301, 302, 303 (the building material suppliers) can transmit the completed transaction information (for example, transaction counterparts, transaction products, transaction prices, transaction amount, etc.) or current supply information (product specifications, product prices, etc.) to the engineering purchase service system 1, and the designer and the building material suppliers edit then store the completed transaction information and the current supply information to be the historical transaction data of the demand end 2 and the supply data of the plurality of supply ends 301, 302, 303 in the supply-demand database 101.

In step S701, when the designer wants to purchase a demand object (for example, product name: H beam; product specification: Height 100 mm×Side 100 mm), the demand end 2 can transmit the inquiry data including the demand object (product name: H beam; product specification: Height 100 mm×Side 100 mm) and a preset condition (for example, the highest price: A dollars/beam; demand amount: B; delivery period: C days) to the receiver module 102 via the network 100.

In step S702, after the receiver module 102 has transmitted the inquiry data to the processing module 103, the processing module 103 performs synonym retrieval including synonym of measurement units, product names and service names to the historical transaction data of the demand end 2 and the supply data of the supply ends 301, 302, 303 according to the demand object (product name: H beam, product specification: Height 100 mm×Side 100 mm). The synonym retrieval of measurement units includes synonymous length, weight, temperature, pressure, power, flow rate units, etc. The synonym retrieval of product names and service names include synonym of the same or different languages, for example, synonym of Chinese and English.

In this embodiment, the processing module 103 retrieves synonym of measurement units “Height 100 mm×Side 100 mm, H beam” and “9.3 kg/m, H beam” and synonym of product names “H beam”, “H shape steel” and “I beam” according to the demand object and specification thereof. When the processing module 103 finds out the supply end 3 including the synonym conforming to the demand object “H beam” from the historical transaction data and the hierarchical items (for example, “shape steel”) or keywords (for example, “H beam”, “H shape steel”, “I beam”) in the input field of the supply data, the processing module 103 lists the other supply ends 3 (for example, the supply end 31 of an H beam supplier, the supply end 302 of an H shape steel supplier and the candidate supply end 303 of a I beam supplier) as candidate supply ends which are located on the hierarchical item in the classification group same as the supply end 3 including the synonym conforming to the demand object (product name: H beam; product specification: Height 100 mm×Side 100 mm).

Then, according to the preset condition (the highest price: A dollars/beam; demand amount: B; delivery period: C days), the processing module 103 filters the candidate supply ends (for example, a sale price P1 of the supply end 301 less than A; a sale price P2 of the supply end 302 equal to A; a sale price P3 of the supply end 303 greater than A) to produce at least an inquiry supply end (the supply ends 301 and 302) conforming to the preset condition. Then, corresponding to the inquiry supply end (the supply end 301 and 302), the processing module 103 produces an inquiry form (for example, inquiry object: H beam; amount: B: delivery period: C days after contracting; quoting deadline: D days after the inquiry form received) including the supply data of the inquiry supply end.

In step S703, according to the communication data (for example, e-mail, mobile phone number) of the inquiry supply ends (the supply ends 301 and 302) stored in the supply-demand database 101, the transmission module 104 automatically transmits an inquiry message with the inquiry form to the inquiry supply ends (the supply ends 301 and 302). The inquiry form transmitted by the transmission module 104 can be a web page of the engineering purchase service system 1, the inquiry supply ends (the supply ends 301 and 302) can directly input or edit a quotation on the inquiry form (the web page of the engineering purchase service system 1), the receiver module 102 transmits the quotation input by the inquiry supply ends (the supply ends 301 and 302) to the processing module 103, the processing module 103 converts the inquiry form with the input quotation to quotation forms of the inquiry supply ends (the supply ends 301 and 302), and quotation messages with the quotation forms are automatically transmitted to the demand end 2 by the transmission module 104. In an embodiment, the supply end 3 can be the mobile communication devices which have installed the intelligent cloud search system of the present application, so that the suppliers of the inquiry supply ends (the supply ends 301 and 302) can instantly input or edit the quotation on the inquiry form (the web page of the engineering purchase service system 1) by using the mobile communication devices after the inquiry message is received.

In this embodiment, the engineering purchase service system 1 provides an input field for setting a plurality of sub conditions of the preset condition, the plurality of sub conditions of the preset condition includes but not limited to: supply specification, price range, supply amount, supply location, quotation deadline, supply period and transaction score. The engineering purchase service system 1 can further provide the demand end 2 to set same or different weight value for each sub condition (for example, sub condition 1: price range, weight value: 50%; sub condition 2: supply period, weight value: 30%; sub condition 3: transaction score, weight value: 20%), so that the processing module 103 can produce the inquiry supply end from the candidate supply end based on the weight values of the sub conditions.

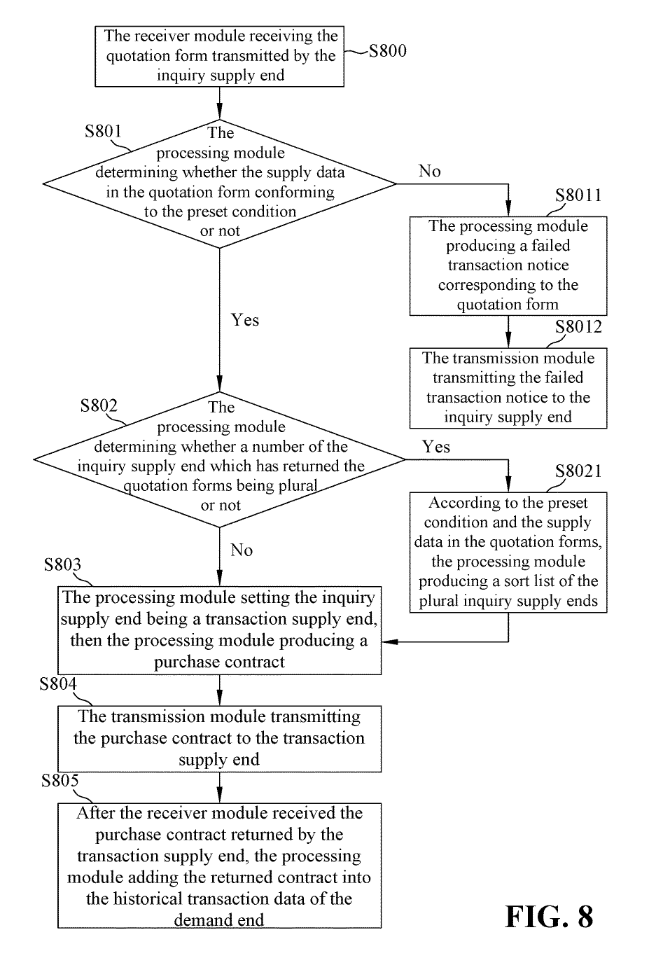

FIG. 8 is a step flowchart illustrating a contracting service for the demand end provided by the engineering purchase service system. As shown in FIG. 8, in step S800, the receiver module 102 receives the quotation forms transmitted by the inquiry supply ends (the supply ends 301 and 302); in step S801, the processing module 103 determines whether the supply data in the quotation form conforming to the preset condition (the highest price: A dollars/beam; amount: B; deliver period: C days) or not; if a result determined is yes, the process proceeds to step S802, the processing module 103 further determines whether a number of the inquiry supply end, which has transmitted the quotation form, being plural or not; if a result determined is not (for example, only transmitted by the supply end 301), the process proceeds to step S803, the processing module 103 sets the inquiry supply end (the supply end 301) being a transaction supply end (the supply end 301), then the processing module 103 produces a purchase contract; in step S804, the transmission module 104 transmits the purchase contract to the transaction supply end (the supply end 301); then in step S805, after the receiver module 102 has received the purchase contract returned by the transaction supply end (the supply end 301), the processing module 103 adds the returned contract into the historical transaction data of the demand end 2 in the supply-demand database 101.

According to the embodiment of the inquiry service for the demand end, in step S800, the quotation forms transmitted by the inquiry supply ends (the supply ends 301 and 302) can be the inquiry form (the web page of the engineering purchase service system 1) having the quotation input therein. In another embodiment, the inquiry supply ends (the supply ends 301 and 302) can edit the supply data stored in the supply-demand database 101 to produce the quotation forms (the web pages of the engineering purchase service system 1, or a document of format xlsx, xml or xls) for adjusting the quotation item (for example, quoting new products or service), then the inquiry supply ends (the supply ends 301 and 302) transmits the quotation forms to the receiver module 102.

In step S801, if the processing module 103 determines the supply data in the quotation form not conforming to the preset condition (for example, the quoted price more than A dollars/beam, deliver period over C days, or date of quoting late than the quotation deadline D days after the quotation message received), the process proceeds to step S8011, the processing module 103 produces a failed transaction notice corresponding to the quotation form; and in step S8012, the transmission module 104 transmits the failed transaction notice to the inquiry supply ends (the inquiry supply ends 301 and 302), the failed transaction notice can be a rejection notice, a price negotiation notice or the like.

In step S802, if the processing module 103 determines the number of the inquiry supply end, which has transmitted the quotation form, being plural (for example, the supply ends 301 and 302, the process proceeds to step S8021, according to the preset condition (the highest price: A dollars/beam) and the supply data in the quotation forms (the quoted price P1 of the supply end 31 less than A, the quoted price P2 of the supply end 302 equal to A), the processing module 103 calculates the difference thereof, then the processing module 103 produces a sort list of the plural inquiry supply ends (for example, the first priority: the supply end 301; the second priority: the supply end 302) for the demand end 2 to select the transaction supply end (for example, the supply end 301); and then the process proceeds to step S803.

In steps S803, S804 and S805, the demand end 2 can set the engineering purchase service system 1 manually or automatically add electronic visa to the purchase contract (a web page of the engineering purchase service system 1), the transmission module 104 transmits the purchase contract with the electronic visa of the demand end 2 to the transaction supply end (the supply end 301), the transaction supply end (the supply end 301) can directly add an electronic visa to the purchase contract, and the purchase contract with the electronic visas of the transaction counterparts is thus completed and returned. The receiver module 102 transmits the purchase contract returned by the transaction supply end (the supply end 301) to the processing module 103, the processing module 103 adds the returned purchase contract into the supply-demand database 101, and a purchase contract completed message is automatically transmitted to the demand end 2 and the transaction supply end (the supply end 31).

In addition, after the demand end 2 and the supply end 3 completed physical transaction, the demand end 2 and the supply end 3 can log in the engineering purchase service system 1 to enter transaction score (for example, 0 to 10) of the counterparts in this transaction, the processing module 103 can add this transaction score into the supply-demand database 101 to be the preset condition for the demand ends 2 inputting the inquiry data, or to be a reference for the supply ends 3 to determine the quotation.

In summary, the engineering purchase service system of the present application includes the supply-demand database, the receiver module, the processing module and the transmission module, wherein the processing module perform the synonym retrieval to the historical transaction data and the supply data stored in the supply-demand database according to the inquiry data transmitted by the demand end, then the processing module produces at least one inquiry supply end and the inquiry form conforming to the inquiry data, and the transmission module can automatically transmit the inquiry form to the inquiry supply end. By integrating the historical transaction data of the demand ends and the supply data of the supply ends, the engineering purchase service system of the present application can automatically produce the forms relative to the engineering purchase such as inquiry, quotation, contract and the like, the engineering industries can use the engineering purchase service system to complete all the engineering purchase jobs, so that manpower and operation time of the engineering purchase jobs can be significantly reduced, and an instant and convenient engineering purchase service can be obtained.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An intelligent cloud search system, comprising:
a control module, controlling operations of the intelligent cloud search system and comprising a storage module, wherein the storage module stores at least a user document of at least a user;
a cloud transmission module, connected to the control module and transmitting the user document via a cloud network, wherein the user document has at least a historical information;
a cloud edit module, connected to the control module and performing an edit process to the historical information of the user document via the cloud network;
a cloud computation module, connected to the control module and performing a computation process to the historical information of the user document via the cloud network; and
a synonym search module, connected to the control module and searching at least a real-time information synonymous to the historical information via the cloud network.

2. The intelligent cloud search system according to claim 1, further comprising a public construction cost estimate system (PCCES) file producing module which has an algorithm and converts the user document to a file compatible to a format of PCCES.

3. The intelligent cloud search system according to claim 1, wherein the intelligent cloud search system is installed and disposed in a mobile communication device or a personal computer device.

4. The intelligent cloud search system according to claim 1, wherein the cloud transmission module includes a mobile application module and a web page application module, the mobile application module is connected to at least a mobile communication device, and the web page application module is connected to at least a terminal device.

5. The intelligent cloud search system according to claim 1, wherein the real-time information and the historical information include one of a financial statement, an engineering quotation, a budget compilation, a research paper and a publication work, and/or a combination thereof.

6. The intelligent cloud search system according to claim 1, wherein the synonym search module includes a search module and a synonym identification module, the search module performs a search for the real-time information and/or the historical information via the cloud network, the synonym identification module performs a synonym identification to the real-time information and/or the historical information via the cloud network.

7. The intelligent cloud search system according to claim 6, wherein the synonym identification module includes an artificial neural network (ANN) computation model.

8. The intelligent cloud search system according to claim 1, wherein the cloud computation module includes a string parse unit and a formula computation unit, the string parse unit performs a string parse to the historical information in the user document, and the formula computation unit performs a formula computation to the historical information in the user document.

9. The intelligent cloud search system according to claim 1, further comprising an identity identification module, wherein the identity identification module performs an identification to an identity information of the user via the cloud network, the identity information includes one of a password, a phone number, a birthday, a fingerprint, a voiceprint, an electronic mail, a face recognition and a QR Code, and/or a combination thereof.

10. The intelligent cloud search system according to claim 1, the cloud edit module is compatible to documentation format of Microsoft Office, OpenOffice and hypertext markup language (HTML).

11. An engineering purchase service system, comprising:
a supply-demand database, having stored historical transaction data of at least a demand end and supply data of a plurality of supply ends;
a receiver module, receiving inquiry data transmitted by the demand end through a network, wherein the inquiry data comprises a demand object and a preset condition;
a processing module, performing synonym retrieval to the historical transaction data and the supply data according to the demand object so as to produce a plurality of candidate supply ends conforming to the demand object, and filtering the plurality of candidate supply ends according to the preset condition so as to produce at least an inquiry supply end and an inquiry form conforming to the preset condition, wherein the inquiry form comprises the supply data of the inquiry supply end corresponding to the demand object; and
a transmission module, transmitting the inquiry form to the inquiry supply end via the network.

12. The engineering purchase service system according to claim 11, wherein the demand end has installed the intelligent cloud search system according to claim 1, when the demand end transmits the inquiry data, the intelligent cloud search system installed therein synchronously transmits an instruction of performing the synonym retrieval according to the demand object.

13. The engineering purchase service system according to claim 11, wherein the preset condition comprises a plurality of sub conditions, each sub condition has a weight value that is identical to or different from the other sub conditions for the processing module filtering the plurality of candidate supply ends.

14. The engineering purchase service system according to claim 13, wherein the plurality of sub conditions comprises a supply specification, a price range, a supply amount, a supply location, a quoting deadline, a supply period and a transaction score.

15. The engineering purchase service system according to claim 11, wherein the synonym in the synonym retrieval comprises at least a synonym of measurement units, product names and service names.

16. The engineering purchase service system according to claim 11, when the receiver module receives a quotation form transmitted by inquiry supply end, the processing module determines whether the supply data in the quotation form conforming to the preset condition or not; if a result determined is yes, the processing module determines whether a number of the inquiry supply end, which has returned the quotation form, being plural or not; if a result determined is not, the processing module sets the inquiry supply end being a transaction supply end, then the processing module produces a purchase contract; and the transmission module transmits the purchase contract to the transaction supply end.

17. The engineering purchase service system according to claim 16, if the result determined is the supply data in the quotation form not conforming to the preset condition, the processing module produces a failed transaction notice corresponding to the quotation form; and the transmission module transmits the failed transaction notice to the inquiry supply end.

18. The engineering purchase service system according to claim 17, wherein the failed transaction notice is a rejection notice or a price negotiation notice.

19. The engineering purchase service system according to claim 16, if the result determined is the number of the inquiry supply ends, which have transmitted the quotation form, being plural, the processing module further produces a sort list of the plural inquiry supply ends according to the preset condition and the supply data in the quotation forms for the demand end to select the transaction supply end.

20. The engineering purchase service system according to claim 16, when the receiver module receives the purchase contract returned by the transaction supply end, the processing module adds the returned purchase contract into the historical transaction data of the demand end in the supply-demand database.
